(19) United States
(12) Patent Application Publication
(10) Pub. No.: US 2014/0103679 A1
(43) Pub. Date: Apr. 17, 2014

(54) Compact poldable automobile sun-shield which is semi-permanently installed

(71) Applicant: Jung Y. You, Alpharetta, GA (US)

(72) Inventor: Jung Y. You, Alpharetta, GA (US)

(21) Appl. No.: 13/573,949

(22) Filed: Oct. 15, 2012

(51) Int. Cl. B60J 3/02

(52) U.S. Cl. 296/97.6

(57) ABSTRACT

A foldable sun-shield for an automobile windshield which, when unfolded and hung from supports for both of the vehicle's sun visors and for its rear view mirror, defines a generally semicircular structure. So hung, the semicircular structure, which includes two elongated frame members, a clamp hingedly connected thereto, and a fan-like working element attached to the frame members and held in assembled relation with them by the clamp, covers most of the windshield. For storage, rather than removing the sun-shield, one disengages only those straps used to hang it from the sun visor support on the driver's side; and the sun-shield, while still semi-permanently hung from the supports for the passenger's side sun visor and the rear view mirror, is folded into a compact package. Thus stored, the sun-shield obstructs very little of the driver's view of the road and can be deployed in seconds.

### BACKGROUND OF THE INVENTION

1. Field of the Invention

The present invention relates to foldable sun-shields for the automobile windshield and more particularly to such sun-shields which, in both their folded and extended configurations, are semi-permanently mounted contiguous with the windshield.

2. Brief Description of the Prior Art

Sun-shields come in various shapes; and most of them are designed to be placed against the interior of a car's windshield after the vehicle has been parked. One of the most popular sun-shields is held in place by first resting its lower edge on the top of the dashboard and then rotating the car's sun visors downwardly so as to juxtapose portions of the sun-shield's upper edge between the visors and the windshield. Covered on one side with a thin layer of a highly reflective material, this prior art sun-shield, properly oriented, can substantially reduce the amount of solar radiation which would otherwise be trapped within a vehicle. Unfortunately, this sun-shield, even when folded and fastened together with a pair of elastic bands or the like, still measures approximately 27 inches long by 6 inches wide by ¼ inch thick and, like sun-shields in general, is too large to place in the glove compartment or under the seat. As a consequence, a passenger in the vehicle has a good chance of inadvertently damaging the sun-shield by sitting or stepping on it. Moreover, experienced users of such a sun-shield find that, at a minimum, approximately two minutes must be consumed every time they retrieve, unfold and place it against a windshield—that is, whenever they ready the sun-shield for use.

### SUMMARY OF THE INVENTION

The object of the present invention is to provide a foldable sun-shield for an automobile which is semi-permanently mounted contiguous with the windshield in such a way that, when it is unfolded in its working position, it covers most of the windshield and, when it is folded for storage, the sun-shield offers only very minimal obstruction to the driver's view of the road.

A further object is to provide such a sun-shield which can be unfolded from its storage position and deployed, ready for use, in seconds.

In accordance with the present invention, there is provided a foldable sun-shield which, when completely unfolded, defines a generally semicircular structure, the semicircular structure including a pair of elongated frame members, a clamp hingedly connected to one end of each of the frame members, and a working element which is permanently creased so as to form multiple folds like those in the bellows of an accordion, with the working element being fixedly attached, along its distal sides, to the frame members and with the clamp pressing the hinged ends of the frame members against a portion of the working element juxtaposed between them. The hinges which connect the clamp to the frame members do so in such a way that the frame members together with the working element can be rotated about them; and as a result, the semicircular structure resembles a large, hand-held fan in use.

Means for mounting the sun-shield semi-permanently and continguously with the windshield includes at least two tie-down elements which are spaced apart along one of the frame members and fixedly attached to it, with one tie-down element positioned midway between the frame member's distal ends. In the preferred embodiment, one of these tie-down elements is an elastic strap with a small hook; this strap and hook in combination are used to attach the sun-shield to a visor support on the passenger's side of the automobile. The second tie-down element preferably comprises a wire which, in use, is wrapped about the rear view mirror support arm. An additional elastic strap affixed to the same frame member as the other two tie-down elements but distal from them can also be employed to mount the sun-shield by securing this third tie-down element to the right end of the visor support arm on the passenger's side.

In the preferred embodiment, a strap having a Velcro® closure mechanism is also fixedly attached to the same frame member as are the tie-down elements. The latter strap is wrapped around the other frame member and holds the sun-shield in its folded position for storage. To deploy the sun-shield, one unfastens the Velcro® strap and rotates the frame member thus freed downwardly and then upwardly along a semicircular arc until the two frame members are aligned generally longitudinally. Yet another elastic strap with a hook on its end, but a strap which is fixedly attached to the frame member now positioned proximate with the visor on the driver's side is next employed to secure the latter frame member to the support arm of this visor.

### BRIEF DESCRIPTION OF THE DRAWINGS

FIG. 1 is a view, as seen through the windshield of an automobile, of the unfolded sun-shield according to the present invention, the sun-shield being shown attached to the support arm of the rear view mirror and to both sun visors' supports;

FIG. 2 is a view, as seen from the inside of the automobile, of the unfolded sun-shield according to FIG. 1;

FIG. 3 is a view, from the inside of the automobile, of the folded and stored sun-shield;

FIG. 4 is a side view of the folded sun-shield;

FIG. 5 is a top plan view of the folded sun-shield;

FIG. 6 is a left-hand end view of the folded sun-shield;

FIG. 7 is a right-hand end view of the folded sun-shield;

FIG. 8 is a longitudinal cross-section, on an enlarged scale, of a fragmentary portion of the sun-shield, which shows coupled clamps pressing the hinged ends of the sun-shield frame members against a permanently folded portion of the working element, with sections of the frame members being shown as fragments in longitudinal cross-section;

FIG. 9 is an end view of the fully opened sun-shield according to FIG. 1; and

FIG. 10 is an end view of an alternate embodiment of the sun-shield when it has been fully opened.

### DETAILED DESCRIPTION OF THE PREFERRED EMBODIMENT

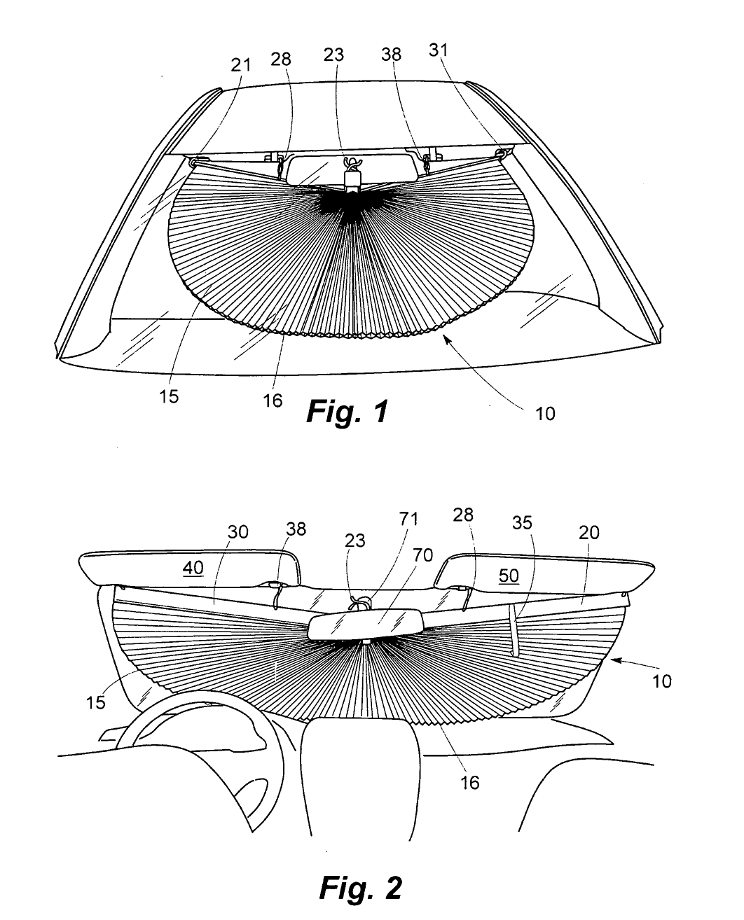

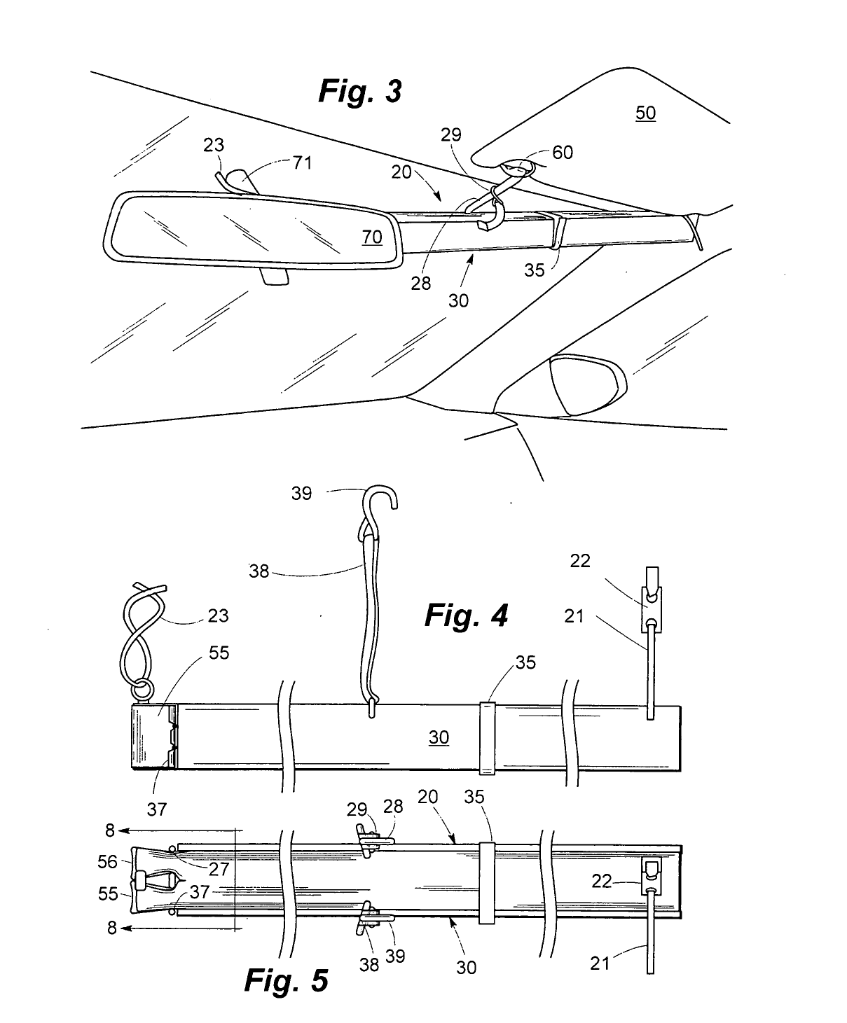

In the drawings, the sun-shield according to the present invention is indicated generally by the reference numeral 10. The sun-shield 10 includes two frame members 20, 30 to which the sun-shield's working element 15 is attached. The working element 15, fabricated of paper, flexible plastic, cloth or the like, is permanently creased into multiple folds 16 which are arrayed like those in the bellows of an accordion (FIGS. 1-2).

As is best illustrated in FIG. 8, coupled spring clamps 55, 56 hold and press the hinged ends of the frame members 20, 30 against a portion of the working element 15, Elongated sections of the frame members 20, 30 extend longitudinally away from their respective hinged ends.

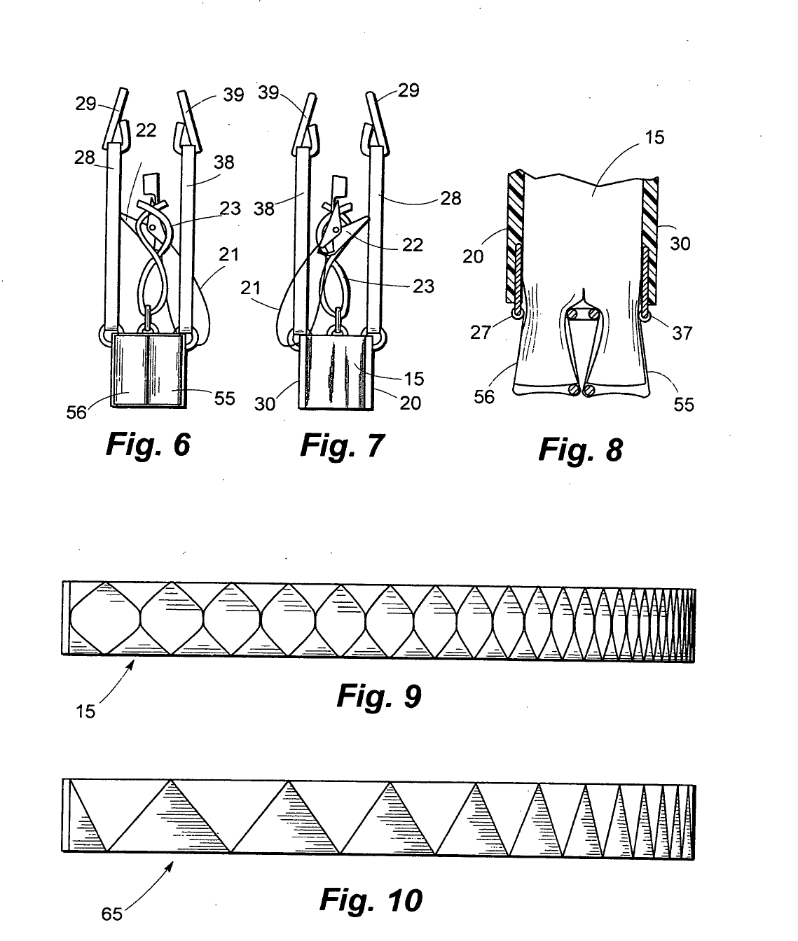

In the preferred embodiment, the overall length of the sun-shield 10 in its folded or stored configuration is about 24 inches; and its transverse cross-section, when the sun-shield is completely folded, is a square which measures about 1½ inches on a side (FIGS. 6-8). Because of variations in windshields between various automobile makes and models, one needs to measure the distance between the outer visor supports of a particular vehicle in order to determine the best fit for it in terms of the sun-shield's overall length. Several sizes of the sun-shield 10 can be offered to accommodate these variations in spacing between outer visor supports.

In order to semi-permanently mount the sun-shield 10 in a conventional automobile, at least two tie-down elements are provided. The frame member 20 is supported by a strap 28 having a hook 29 which can be fastened about the visor support 60 and a wire 23 which is wrapped about the support arm 71 of the rear view mirror 70. An additional strap 21 with a clip 22 can also be utilized to support the frame member 20 by tying the strap 21 and/or attaching the clip 22 to the righthand support arm of the visor 50 on the passenger's side.

One positions the sun-shield for use by unfastening the Velcro® closure of the strap 35 so that the frame member 30 is free to be rotated downwardly and then upwardly along a semi-circular arc. Affixed to the frame member 30 are straps 31, 38 with a clip and hook 39, respectively, either one of which or both can be used to secure the frame member 30 to the visor 40 and its support arm on the driver's side (FIGS. 1, 2, 4, 6 and 7). So secured, the sun-shield 10 is now in position for use.

In the preferred embodiment, the working element 15 is double-layered so that when the sun-shield 10 is unfolded, it has the appearance of a honeycomb structure (FIG. 9). The outer surface of the working element 15 is preferably either silvered or light in color to reflect the sun's rays and reduce the build-up of heat in the car from trapped solar radiation. Moreover, the double-layered working element 15, which is fabricated of paper, plastic, cloth or the like, offers good insulation as far as reducing the transfer of heat from the working element's outer surface to the interior of the automobile.

An alternate embodiment shown in FIG. 10 includes a single layer working element 65, also fabricated of paper, plastic, cloth or the like. Except for the working element 65, the alternate embodiment has identical components to that of the sun-shield 10 but is substantially lower in cost to manufacture.

It is claimed:

1. A sun-shield for an automobile windshield, which comprises:
a) first and second elongated frame members;
b) a clamp hingedly connected to one end of each of the frame members;
c) a foldable working element which defines multiple folds arrayed similarly to those in the bellows of an accordion, the working element having first and second elongated sides which are spaced apart and fixedly attached to the first and second elongated frame members, respectively;
d) the clamp pressing the hinged ends of the elongated frame members against a portion of the working element which is juxtaposed between them; and
e) means, attached to the first elongated frame member, for semi-permanently hanging it from the supports for the passenger's side sun visor and the rear view mirror; the elongated frame members, when the working element is folded compactly, being spaced apart by its folds but aligned longitudinally and generally side-by-side; the elongated frame members and the compactly folded working element in combination, when the first elongated frame member is so hung, obstructing very little of the driver's view of the road.

2. The sun-shield according to claim 1, wherein the second elongated frame member is further characterized as being rotatable about its hinged connection with the clamp into a position in which the second elongated frame member extends longitudinally generally parallel to the first elongated frame member but in a direction away from it; and wherein the sun-shield further comprises means, attached to the second elongated frame member, for hanging it from the support for the driver's side sun visor, once the second elongated frame member has been so rotated into said position, so that the sun-shield can be fully deployed for use while the first elongated frame member is still semi-permanently hung from the supports for the passenger's side sun visor and the rear view support.

3. The sun-shield according to claim 1, wherein the foldable working element is further characterized as including dual layers of material interconnected internally by a foldable, honeycomb-like structure which, when the working element is unfolded in use, forms multiple air pockets between the dual layers, thereby enhancing the sun-shield's capacity to act as a barrier to the transfer of solar heat.

4. A sun-shield for an automobile windshield, which comprises:
a) first and second elongated frame members;
b) a clamp hingedly connected to the end of at least one of the frame members;
c) a foldable working element which defines multiple folds, the working element having first and second elongated sides which are spaced apart and fixedly attached to the first and second elongated frame members, respectively;
d) the clamp holding a portion of the working element, contiguous with the clamp's hinged connection with said end of one of the frame members, in assembled relation with both of them;
e) the elongated frame member hingedly connected to the clamp being rotatable into a position in which the first elongated frame member extends longitudinally generally parallel to second elongated frame member but in a direction away from it; and
f) means for holding the first and second elongated frame members in said longitudinally extending position.

5. The sun-shield according to claim 4, wherein the working element, when unfolded for use, defines a generally semicircular structure which covers most of the windshield.
